(19) United States
(12) Patent Application Publication
(10) Pub. No.: US 2014/0368044 A1
(43) Pub. Date: Dec. 18, 2014

(54) RAIL INTEGRATED ENERGY SYSTEM

(71) Applicant: ELECTRO-MOTIVE DIESEL, Inc., La Grange, IL (US)

(72) Inventor: JEFFREY EDWARD JENSEN, DUNLAP, IL (US)

(21) Appl. No.: 14/474,429

(22) Filed: Sep. 2, 2014

(51) Int. Cl. H02J 7/34; B60L 8/00; B60L 9/00; H02J 1/10

(52) U.S. Cl. CPC H02J 7/34; H02J 1/10; B60L 8/00; B60L 9/00
USPC 307/69

(57) ABSTRACT

An energy management system using renewable energy resources to power an electric railcar along a rail and to distribute and store energy along a rail system is disclosed. The energy management system includes a power supply structured to generate electricity from renewable energy resources. A rail tie assembly, with a rail tie member, is positioned to support the rail and encloses a battery therein. The battery is electrically connected to the power supply. The rail tie assembly also includes at least one electricity transmission line, which is electrically connected to the battery and a railcar power transmission assembly. More specifically, the energy management system is structured to conduct electricity between the power supply and the battery, and to distribute power to a battery of an adjoining rail tie assembly.

### TECHNICAL FIELD

The present disclosure generally relates to an energy management system. More specifically, the present disclosure relates to using renewable energy available along railway lines.

### BACKGROUND

Railway lines around the world run through various geographical terrains. Electric railcars make up a portion of the overall railcars that run along these lines and most railcars utilize conventional energy sources, such as diesel, natural gas, and coal-fired steam power, for locomotion. Some applications use energy provided via electricity grids that run on coal, and/or natural gas. These energy sources are non-renewable, expensive, emit emissions and are generally finite in quantity in the environment. Accordingly, research is conducted to minimize losses incurred during energy generation and transmission along electrical transmission lines Improvement of power generation, storage and distribution is important in this regard in order to address the area where researchers may be able to make greater gains in energy savings related to efficient operation of electric railcars and the network of systems supporting the same. Efforts are underway to reduce the current level of energy use and there is a growing need to seek options to maximize the use of renewable energy.

Some countries' use of fossil fuel to power utilities and transportation, have gradually shifted to increased utilization of renewable energy options, such as solar power, wind power, geothermal power, tidal power, and wave power. New methods and applications for generating and utilizing renewable energy, including those for solar power, wind power, geothermal power, tidal power, and wave power are being explored so that less fossil fuel may be used. New methods are also needed, however, for distributing and storing the energy produced from these renewable, but intermittent and dispersed, energy sources.

### SUMMARY OF THE DISCLOSURE

Various aspects of the present disclosure describe an energy management system that uses renewable energy resources to power an electric railcar along a rail and to distribute and store that energy along a rail system. The energy management system includes a power supply structured and arranged to generate electricity from renewable energy resources. A rail tie assembly with at least one rail tie member is positioned to support the rail. Further, the rail tie assembly is structured and arranged to enclose a battery within. The battery is electrically connected to the power supply. Moreover, the rail tie assembly includes at least one electricity transmission line electrically connected to the battery and a power consumption location. Additionally, the energy management system is structured and arranged to conduct electricity between the power supply and the battery, and to distribute power to a battery of an adjoining rail tie assembly.

Other features and advantages of the disclosure will become apparent to those skilled in the art, upon review of the following detailed description and drawings.

### BRIEF DESCRIPTION OF DRAWINGS

FIG. 1 is a schematic of an exemplary energy management system, in accordance with the concepts of the present disclosure;

FIG. 2 is an exemplary rail system of the energy management system of FIG. 1, in accordance with the concepts of the present disclosure;

FIG. 3 is an exemplary sectional view that depicts transmission lines integrated within the energy management system of FIG. 1, in accordance with the concepts of the present disclosure; and

FIG. 4 is an exemplary rail network that employs the energy management system of FIG. 1, in accordance with the concepts of the present disclosure.

### DETAILED DESCRIPTION

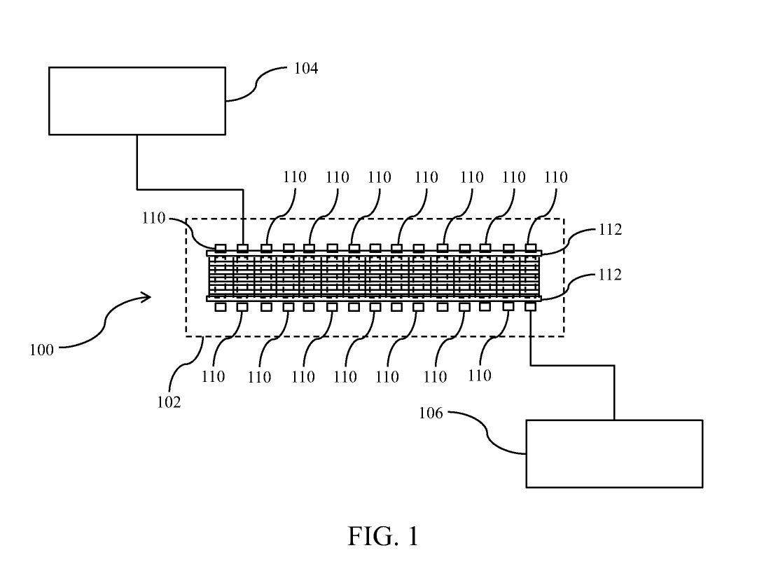

FIG. 1 is a schematic of an exemplary energy management system 100, in accordance with the concepts of the present disclosure. The energy management system 100 includes a rail tie assembly 102, a power supply 104 connected to the rail tie assembly 102, and an power consumption location 106, also connected to the rail tie assembly 102. The rail tie assembly 102 includes a number of rail tie members 110 and one or more rails 112.

The rail tie assembly 102 may be a conventional railway track arrangement formed by a sequential array of rail tie members 110, as shown. The rail tie members 110 may have substantially rectangular shaped cross-sections and be adapted to support the one or more rails 112, as is customary. The rail tie members 110 offer support for the rails 112 and have designated portions to connect the rails 112. The rails 112 are generally arranged as a pair, which are positioned parallel to each other to comply with standard rail gauge sizes. The rail tie members 110 may be structured to transfer loads to a track ballast (not shown). It will be understood that measures to support the rails 112 in relation to the rail tie members 110 include conventionally applied springs, tie plates and spikes, and/or Pandrol™ fast clips (not shown), or other support and fastening means known to those having ordinary skill in the art.

Each of the rail tie members 110 may be a prefabricated structure that suits conventional railway layouts. Example materials used in manufacturing the rail tie members 110 may include wood, concrete, iron, and/or steel. Composite materials that exhibit enhanced resistance towards stress, temperature variations, pressure variations, moisture, insects, and dust, may be considered as well.

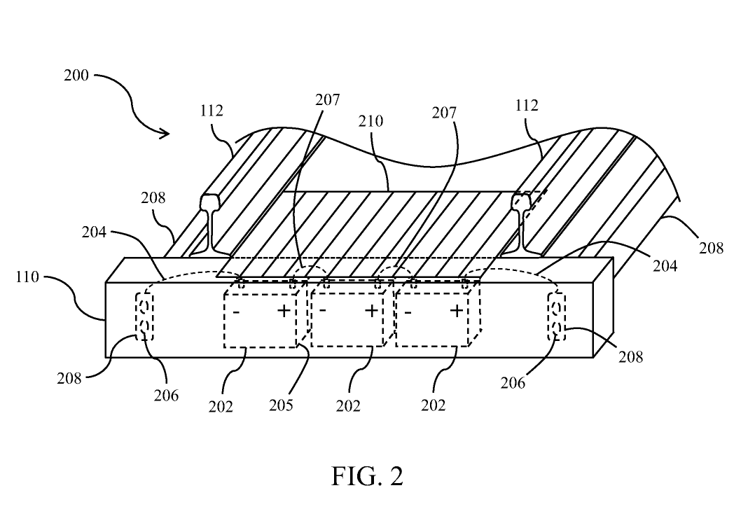

At least one rail tie member 110 includes at least one enclosure 205 (see FIG. 2) structured and arranged to enclose a battery 202 (see FIG. 2). The present disclosure contemplates the use of other embodiments of rail tie assembly alternatives, known to those with ordinary skill, which possess storage spaces in a portion of the rail tie members 110 along the length of the rail tie assembly 102.

The power supply 104 is an electricity generation source, such as solar power, for example. Other renewable power options, such as wind turbines, geothermal, tidal or wave power, may be used and are contemplated as energy sources by the present disclosure. Additionally, remotely located solar power stations or wind power stations may provide electricity as well. In the present disclosure, the power supply 104 may correspond to a solar panel 210 (see FIG. 2).

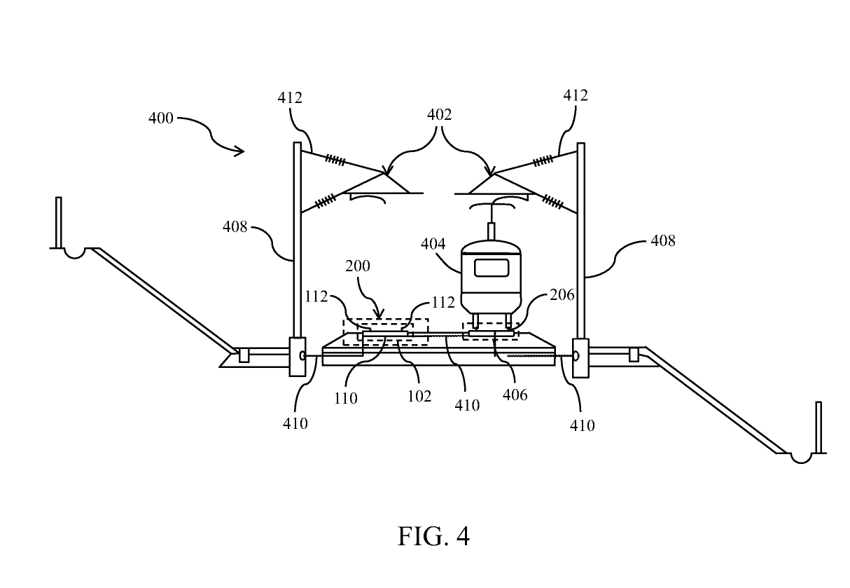

The power consumption location 106 acts as a load to which generated and stored energy is transferred to produce useful work. This power consumption location 106 can be in the form of utilities located along the length of the rail tie assembly 102, utilities located remotely and separately, but electrically connected to the rail tie assembly 102, electrical grids, or a railcar that runs over the rails 112. In an exemplary embodiment, therefore, the generated energy runs an electric railcar 404 (see FIG. 4). Moreover, the power supply 104 conducts electricity and supplies power to the batteries 202 (see FIG. 2), which may be placed in alternate rail tie assemblies 102 or placed in a portion of the rail tie assemblies 102 in a manner such that the railcar 404 (see FIG. 4) is adequately powered along an expanse of a related rail system 200 (see FIG. 2). It is also envisioned that the energy management system 100 of the present disclosure may conduct electricity between the power supply 104 and the batteries 202, to distribute power to the batteries of an adjoining rail tie assembly 406 (see FIG. 4).

Referring to FIG. 2, the rail system 200 includes a solar panel 210, which may correspond to the power supply 104 (see FIG. 1), as already noted. The solar panel 210 is secured between the rails 112 and is mounted above at least one of the rail tie members 110. Mounting brackets (not shown) may be used to attach the solar panel 210 to the rail tie members 110, as is customary. It is further envisioned that the present disclosure contemplates the use of grommets, stand-offs and other known fastening strategies (not shown) known to those having ordinary skill to ensure that the solar panels 210 are properly attached to the rail tie members 110, isolated from vibration and properly protected from common environmental hazards. Solar panel 210 may include one or more conduits, see conduit and insulation assembly 208, which encases electricity transmission line 206 for the transmission of electricity via copper lines, aluminum lines, coaxial lines, and any other conductive transmission lines, known to those having ordinary skill. An inclusion of multiple solar panels 210 may be contemplated, where each solar panel 210 mounts over successive or alternative rail tie members 110. In this manner, certain solar panels 210 along an expanse of the rail system 200 will likely receive more sunlight, and, thus, generate an abundance of solar energy. However, the present disclosure envisions that this surplus energy from power supply 104 and/or solar panels 210 will be stored in the batteries 202 at the site of the solar panels 210. Stored surplus energy may be distributable to other batteries 202 located remote from such solar cells by transmission through the electricity transmission lines 206 via battery jumpers 204, which allow distribution of power to other portions of the rail system 200. Therefore, energy stored in batteries 202 at these surplus sites may be distributed to other batteries 202 in other such rail tie assemblies through electricity transmission lines 206.

Further, various dimensions and shapes for the solar panel 210 may be envisioned, with each solar panel 210 complementary to the shape defined by the assembly of the rails 112 and the rail tie members 110. In some embodiments, solar panel 210 may be curved to follow along a curved railroad. A light receiving portion of the solar panel 210 may be made of a durable glass/plastic substrate or similar material, and may include hydrophobic and anti-glare characteristics to absorb maximum incident rays. When positioned between the rails 112, which may be arranged as a pair, and mounted to the rail tie members 110, the solar panel 210 lies relatively low to provide adequate clearance to a railcar travel. Surfaces of the solar panel 210 that are typically exposed to the sun are constructed such that they are intended to be easy to clean and maintain.

Solar power is generally derived from photovoltaic (PV) systems, silicon-made solar panels, and/or the like. Structurally, an array of solar panels may be interconnected to one or more solar power gathering devices to accumulate and harness energy from the sun. Additionally, solar power may come from thin film solar applications, panelized silicon crystal applications, and/or passive solar design schemes.

The battery 202 is electrically connected to the solar panel 210. The battery 202 may be a standard chemical battery and/or a common charge-storage device, such as the ones applied in commercial electronic devices and passenger vehicles. Customization to the battery 202 may be possible, and thus, known additives may be added for protection from operational stresses and unwanted chemical reactions. Further, being enclosed within the enclosure 205 of the one of the rail tie members 110 protects the battery 202 from adverse weather. The enclosure 205 may be created within the rail tie members 110 which are envisioned to be made from chemically-resistive materials that restrict moisture entrapment and dust entry. In an exemplary embodiment, the use of a low density battery such as a lead-acid based or sodium-nickel-chloride based unit is contemplated, or any other suitable battery known to those with ordinary skill, is also contemplated.

As best seen in FIG. 2, the rail tie members 110 provide a designated storage place or the enclosure 205 to accommodate, protect, and store the battery 202. The enclosure 205 may be contemplated to store multiple batteries 202 and may be may be structured in a number of rail tie members 110. Further, a number of enclosures 205 may be structured within each of the rail tie members 110, as well. The enclosure 205 may include a removable, water-tight cover (not shown) to attain a complete sealed enclosure 205 for the batteries 202. Locks (not shown) may be provided to avoid unauthorized access. More than one battery 202 may be enclosed within the enclosure 205 of the rail tie members 110. Further, mounting dampers, perhaps made of rubber or other chemical resistant and resilient material, may be disposed between the battery 202 and the enclosure 205 to soften vibrations generated by a passing railcar 404 (see FIG. 4).

Each enclosure 205 within certain rail tie members 110 may also include conductive connectors 207 to allow cabled links to connect a number of batteries 202 in a serial formation. Further, a set of batteries 202 within each of the rail tie members 110 may connect an adjacent set of batteries 202 in an adjacent rail tie member 110 through electricity transmission lines 206, which extend through the rail tie members 110 and run parallel to the rails 112. As best seen in FIG. 2 each set of batteries 202 connects to an adjacent set of batteries 202 through jumpers 204 connecting to an associated electricity transmission line 206.

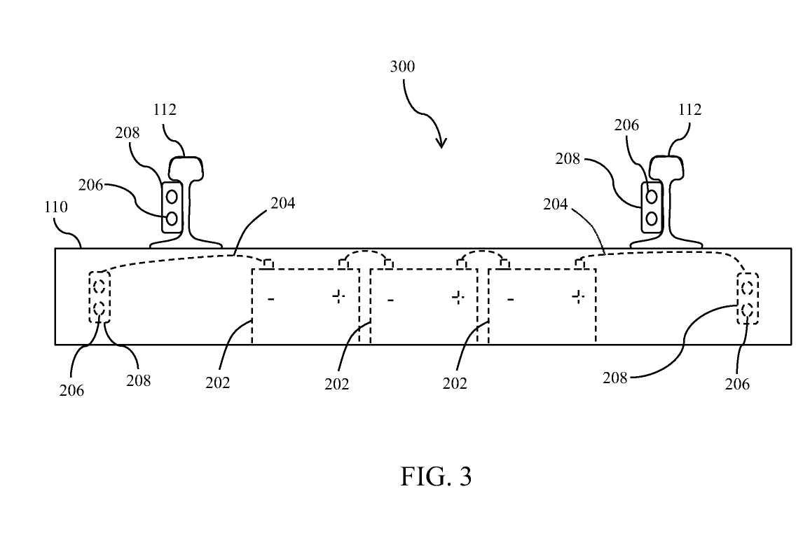

Referring to FIG. 3, a railcar power transmission assembly 300 is shown and includes the electricity transmission line 206 within the conduit and insulation assembly 208. The railcar power transmission assembly 300 may be categorized as a power consumption location 106, as well. Here, the transmission line 206 and the conduit and insulation assembly 208 extend outwards and are arranged along an outer rail portion of the rails 112. The electricity transmission line 206 is electrically connected to the battery 202, through jumper 204 as shown. This arrangement allows the electric railcar 404 (see FIG. 4) to move over the rails 112, without obstructions and hindrance. By having the electricity transmission line 206 connected to the batteries 202, the batteries 202 communicate and deliver power to be distributed to portions of the track lacking proper power levels or ultimately to a power reserve (not shown).

The electricity transmission line 206 directly and electrically links with the battery 202. It will be understood that the electricity transmission line 206, and the battery connections, are positioned in different planes. Accordingly, options may include a transmission line structure that periodically draws current from every rail tie member 110 that houses the batteries 202. In so doing, electrical connections from the battery 202 may directly connect to that drawn transmission line 206 portion. Alternatively, a direct electrical connection may extend from the batteries 202 to supply the electricity transmission line 206 acting as a power source. Passages or conduits may be configured to enable such arrangements. Further, multiple electricity transmission lines 206 may be contemplated.

The electricity transmission line 206 may have the conduit and insulator assembly 208 along its length. The conduit and insulation assembly 208 protects the energy management system 100 from transmission losses, faults, and/or short circuits. Additionally, the conduit and insulation assembly 208 provides protection from dust, moisture, and other environmental dangers. The conduit and insulation assembly 208 includes the conduit for passages of various cable designs, such as the ones having copper lines, aluminum lines and/or coaxial lines, however it is contemplated that some transmission line designs may not require a special conduit since the insulator material is enough to protect the electricity transmission line 206. In an exemplary embodiment, the electricity transmission line 206 acts as a continuous supply for the energy management system 100 by ensuring that an electrical connection is preserved between the stored batteries 202 and an overhead electricity distribution assembly 402 (see FIG. 4).

Alongside the electricity transmission line 206, passages may be provided to lay fiber optic and high-speed internet cables, and the like, via the conduit structure of the conduit and insulation assembly 208. Those arrangements may assist applications within a travelling or commuter railcar. Moreover, rural areas through which the railway network passes, and/or where electrical connections are difficult to reach, may benefit from such an arrangement. In addition, information may be gathered on the state of charge or health of the batteries located along the rail and this information may be transmitted along these lines to optimize system efficiency and maintenance.

FIG. 4 is an exemplary rail network that employs the energy management system, in accordance with the concepts of the present disclosure. FIG. 4 is described in conjunction with figures from FIGS. 1-3. With reference to FIG. 4, a rail integrated energy system 400 is depicted that receives input from the energy management system 100 and supplies a load to operate the railcar 404 with requisite power. It will be understood that the load is the electric railcar 404 and may be the power consumption location 106 identified in FIG. 1. However, the present disclosure also envisions other sources of electricity consumption in addition to railcar 404 especially if the present disclosure energy management system has the capability of providing electricity to other load demands and power storage units to best manage and store power. Therefore, various possible embodiments include loads that consist of an electricity power grid and/or other nearby applications. The rail integrated energy system 400 includes the rail tie assembly 102, overhead electricity distribution assembly 402, electric railcar 404 that runs over the rails 112, an adjoining rail tie assembly 406, catenary masts 408, an electrical extension 410, and electricity cables 412.

The electricity distribution assembly 402 may include a network of the electricity cables 412 to define an exemplary electricity distribution system. Further, a widely employed component set of catenary masts 408 and electricity cables 412 may allow conductive travel path provisions to transmit an electrical charge from the rail system 200 to the electricity distribution assembly 402. Though not limited, this complex layout transmits electrical energy to provide locomotive power to the electric railcar 404.

The electrical extension 410 is configured to receive an electrical current from the electricity transmission line 206. That connection extends underground and connects to the conductive travel path provisions of the catenary masts 408. The electrical extension 410 then extends along the length of the catenary masts 408, and connects the electricity distribution assembly 402, situated overhead, to deliver the electrical current thereof. The electricity cables 412 conductively link the power systems within the electric railcar 404, transmit the charge, and energize the electric railcar 404 for mobility, and optionally, other applications.

The electrical extension 410 is structured and arranged to conductively connect another power consumption location 106, defined by the adjoining rail tie assembly 406. More particularly, as the battery 202 may be topped off based from the electricity generated from the solar panel 210 (or alternately powered directly from one of the solar panel or the battery) the battery 202 stores power and a portion of that energy may also be distributed to a battery of the adjoining rail tie assembly 406. Controllers within the energy management system may gauge requirements that pertain to the percentage of a charge distribution. In addition, power electronics (not shown) in the energy management system 100 would convert/invert the power produced by the power supply 104, solar power supply 210, stored in the batteries 202 and supply to the power consumption location 106 or electric railcar 404. For example, the power produced by the power supply may be high voltage alternating current, whereas the batteries may store power at a lower voltage direct current.

### INDUSTRIAL APPLICABILITY

During operation, solar rays fall on the solar panel 210. The solar panel 210 converts energy radiated from the sun into electrical energy and delivers the electrical energy to the batteries 202. The batteries 202 store the generated electrical energy. During passage of the electric railcar 404, connections of the batteries 202 to the electricity transmission line 206, facilitate transfer of the stored electrical energy to the electricity distribution assembly 402. The electricity distribution assembly 402 receives the electrical energy and powers the electric railcar. The electricity transmission line 206 also distributes power to a battery of the adjoining rail tie assembly 406 through the electrical extension 410.

Therefore, stored energy in the rail system 200 of the energy management system 100 is utilized by the rail system 200, as previously mentioned, and/or utilized by other utilities and transportation related applications where energy is needed. Accordingly, surplus energy stored within the batteries 202 is distributed to electricity grids, electricity deficient areas, and/or the like. Surplus power may also be directed for use on roadways to electrify streetlights, emergency telephones booths, and/or the like. Applications may extend to benefit residential and commercial establishments as well.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. An energy management system for using renewable energy resources to power an electric railcar along a rail and to distribute and store energy along a rail system, the energy management system comprising:
a power supply structured and arranged to generate electricity from renewable energy resources; and
a rail tie assembly including at least one rail tie member positioned to support the rail and being structured and arranged to enclose a battery therein, the battery being electrically connected to the power supply, the rail tie assembly including at least one electricity transmission line being electrically connected to the battery and a power consumption location, wherein
the energy management system is structured and arranged to conduct electricity between the power supply and the battery and distribute power to a battery of an adjoining rail tie assembly.

2. The energy management system of claim 1, wherein the power consumption location is a railcar power transmission assembly.

3. The energy management system of claim 1, wherein the power consumption location is at least one of:
a transportation related application;
a utility; or
an electrical grid.
